(19) United States
(12) Patent Application Publication
(10) Pub. No.: US 2026/0333550 A1
(43) Pub. Date: Oct. 22, 2026

(54) MARINE LIGHTING SYSTEM

(71) Applicant: The Yacht Group, LLC, Coral Gables, FL (US)

(72) Inventor: Gerald Berton, Coral Gables, FL (US)

(21) Appl. No.: 19/339,922

(22) Filed: Sep. 25, 2025

Related U.S. Application Data
(60) Provisional application No. 63/792,034, filed on Apr. 21, 2025.

(51) Int. Cl. H05B 47/17; B63B 45/02; B63B 45/04; F21S 41/153; F21S 41/20; F21S 41/657; F21S 41/663; F21S 43/00; F21S 43/14; F21S 43/20; F21S 45/50; F21W 107/20; H05B 45/10; H05B 47/155; H05B 47/175

(52) U.S. Cl. CPC H05B 47/17; B63B 45/02; B63B 45/04; F21V 14/02; H05B 47/155; B63B 2201/08; F21W 2107/20

(57) ABSTRACT

A marine lighting system comprises an aimable light plate having a first set of lighting elements configured to provide a spot light output, and a second set of lighting elements configured to provide a flood light output. Each of these sets of lighting elements can be activated independently, and/or operated together. The light plate is mounting in a housing that holds the light plate generally vertical, where the light output extends in a horizontal direction, and the light plate can be aimed up and down as needed. The housing is further capable of rotating about a vertical axis so that the light output can be aimed around the vessel, in a full circle around the vessel. The system can be operated in autonomous modes, such as a continuous horizontal sweep from port to starboard, and back. The operator of the system can also enable a strobe mode for defense of the vessel, and an “SOS” mode to signal a need for assistance to other vessels.

### CROSS REFERENCE

This application claims the benefit of provisional Application no. 63/992,034, filed Apr. 21, 2025, the entirety of which is hereby incorporated by reference.

### FIELD OF THE INVENTION

The present invention relates generally to lighting systems for marine vessels, and, more particularly, relates to a self-centering lighting system capable of both spotlight and floodlight operation, with remote control.

### BACKGROUND OF THE INVENTION

Marine vessels often operate during night time, when visibility is very low, making lighting systems very important. On open water, it is important that other vessels be able to see each other. When navigating on inland waterways, especially when crossing bars, entering harbors, travelling in intercoastal waterways, and when docking, it is critical for the pilot to see structure in the water and at the water's edge. Existing lighting systems, while effective, are often difficult to use, especially under less than optimum conditions. For example, it is a common problem that when a spotlight is first activated, it can be difficult to see where the beam of light is pointing, making adjustment of the light via remote controls difficult and slow.

Therefore, a need exists to overcome the problems with the prior art as discussed above.

### SUMMARY

In accordance with some embodiments of the inventive disclosure, there is provided a marine lighting system that includes a light having a housing, and a riser system on which the housing is mounted. The housing is rotatable in a horizontal plane about a vertical axis of the riser system. The housing has a front opening at which a light plate is disposed. The light plate has a plurality of light emitting diode (LED) units in which a first set LED units of the plurality of LED units is configured to provide a flood pattern of light and a second set LED units of the plurality of LED units is configured to provide a spot pattern of light. The light plate is mounted in the housing on a horizontal axis allowing the light plate to tilt up and down. There is also a control unit that is configured to be remote from the light, and which controls operation of the light, including a mode of light output from the light, and motion of the light.

In accordance with a further feature, the housing is automatically rotated forward when the marine lighting system is turned on.

In accordance with a further feature, the housing is automatically rotated rearward when the marine lighting system is turned off.

In accordance with a further feature, when a sweep mode is selected at the control unit, the housing is continuously swept left and right from forward, at one of several selectable sweep speeds, while at least one of the first set of LED units or the second set of LED units are enabled to produce light.

In accordance with a further feature, when an auto rotation mode is selected at the control unit, the housing is continuously rotated while at least one of the first set of LED units or the second set of LED units are enabled to produce light.

In accordance with a further feature, upon selecting a strobe mode at the control unit, at least one of the first set of LED units or the second set of LED units are enabled to produce light in a strobe sequence.

In accordance with a further feature, upon selecting a distress mode at the control unit, at least one of the first set of LED units or the second set of LED units are enabled to produce light in a distress code sequence.

In accordance with a further feature, the light plate is covered with a clear lens made out of ballistic impact material.

In accordance with some embodiments of the inventive disclosure, there is provided a marine lighting system, which includes a riser that is configured to be mounted on a surface. There is also a housing disposed on the riser that is rotatable on the riser about an axis that is perpendicular to the surface. The housing has a front opening. There is a housing motor coupled to the housing at an inside of the housing, or in the riser, that is configured to rotate the housing under automatic or manual control, as selected by a user. There is a light plate that is mounted in the front opening, at opposite sides of the light plate. The light plate is configured to tilt up and down, as controlled either manually or automatically. There is a tilt control in the housing that is responsive to a tilt control signal to adjust a tilt angle of the light plate. There is a first plurality of light elements disposed on a front of the light plate which are configured to provide a flood pattern of light. There is a second plurality of light elements disposed on the front of the light plate which are configured to provide a spot pattern of light. There is also a control unit including actuators for controlling a rotational position of the housing, the tilt angle of the light plate, operation of the first plurality of light elements, and operation of the second plurality of light elements.

In accordance with a further feature, there is further included a camera mounted either on the housing or on the light plate which produces image information, and there is a display that is operatively coupled to the camera which displays the image information graphically.

In accordance with a further feature, the housing motor is operated to automatically aim the housing forward when the marine lighting system is turned on, and operated to automatically aim the housing rearward when the marine lighting system is turned off.

In accordance with a further feature, the housing motor is operated, when a sweep mode is selected at the control unit, to continuously sweep the housing left and right from forward, at one of several selectable sweep speeds, while at least one of the first plurality of lighting elements or the second plurality of lighting elements are enabled to produce light.

In accordance with a further feature, the housing motor is operated, when an auto rotation mode is selected at the control unit, to continuously rotate the housing while at least one of the first plurality of lighting elements or the second plurality of lighting elements are enabled to produce light.

In accordance with a further feature, upon selecting a strobe mode at the control unit, at least one of the first plurality of lighting elements or the second plurality of lighting elements are enabled to produce light in a strobe sequence.

In accordance with a further feature, upon selecting a distress mode at the control unit, at least one of the first plurality of lighting elements or the second plurality of lighting elements are enabled to produce light in a distress code sequence.

In accordance with a further feature, the light plate is covered with a clear lens made out of ballistic impact material.

Although the invention is illustrated and described herein as embodied in a marine lighting system, it is, nevertheless, not intended to be limited to the details shown because various modifications and structural changes may be made therein without departing from the spirit of the invention and within the scope and range of equivalents of the claims. Additionally, well-known elements of exemplary embodiments of the invention have not been described in detail and have been omitted so as not to obscure the relevant details of the invention. Once the lighting system is

Other features that are considered as characteristic for the invention have been set forth in the description. Some detailed embodiments of the present invention have been disclosed herein; however, it is to be understood that the disclosed embodiments are merely exemplary of the invention, which can be embodied in various forms. Therefore, specific structural and functional details disclosed herein are not to be interpreted as limiting, but merely as a basis for teaching one of ordinary skill in the art to variously employ the present invention in virtually any appropriately detailed structure. Further, the terms and phrases used herein are not intended to be limiting; but rather, to provide an understandable description of the invention. The figures of the drawings are not to be taken as being drawn to scale.

It is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present invention, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance.

In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. To the extent that the inventive disclosure relies on or uses software or computer implemented embodiments, the terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system. Those skilled in the art can understand the specific meanings of the above-mentioned terms in the embodiments of the present invention according to the specific circumstances.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective view of the inventive marine lighting system, in accordance with some embodiments.

FIG. 2 shows front and side view of the inventive lighting system.

FIG. 3 show a controller for remote operation of the lighting system, in accordance with some embodiments.

FIG. 4A shows a front view of the marine lighting system including a camera system, in accordance with some embodiments.

FIG. 4B shows a side view of the marine lighting system of FIG. 4A.

FIG. 5 shows a sectional view of a head portion of a marine lighting system, in accordance with some embodiments.

FIG. 6 shows a sectional view of a head portion of a marine lighting system and how the light plate can be tilted to aim the lighting, vertically, in accordance with some embodiments.

FIG. 7 shows a side view of a marine vessel having a marine lighting system mounted thereon, in accordance with some embodiments.

FIG. 8 is a top view of a marine vessel with a marine lighting system with the marine lighting system not in use.

FIG. 9 is a top view of a marine vessel with a marine lighting system that is initially turned on for operation.

FIG. 10 is a top view of a marine vessel with a marine lighting system with marine lighting system operated in an autonomous sweep mode, in accordance with some embodiments.

FIG. 11 is a top view of a marine vessel with a marine lighting system with the marine lighting system being rotated in either a manual or autonomous mode of operation, in accordance with some embodiments.

FIG. 12 is a top view of a marine vessel with a marine lighting system having a camera system, in accordance with some embodiments.

FIG. 13 is a block schematic diagram of a marine lighting system for a marine vessel, in accordance with some embodiments.

FIG. 14 is a state diagram of operation of a marine lighting system for a marine vessel, in accordance with some embodiments.

FIG. 15 is a block schematic diagram of a marine lighting system for a marine vessel, in accordance with some embodiments.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

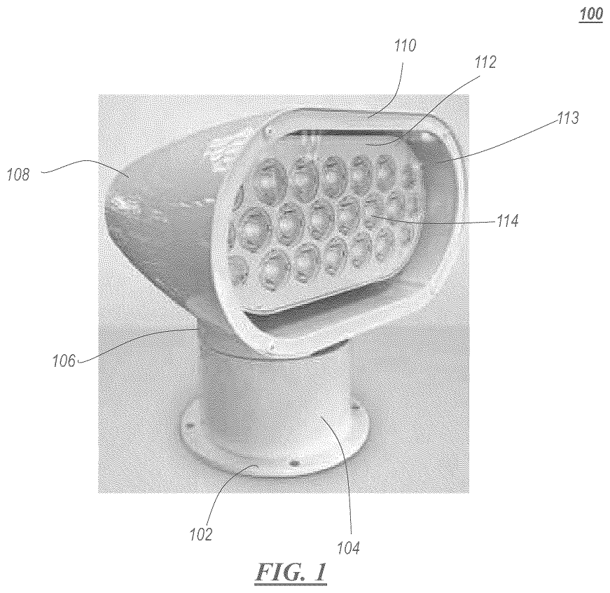

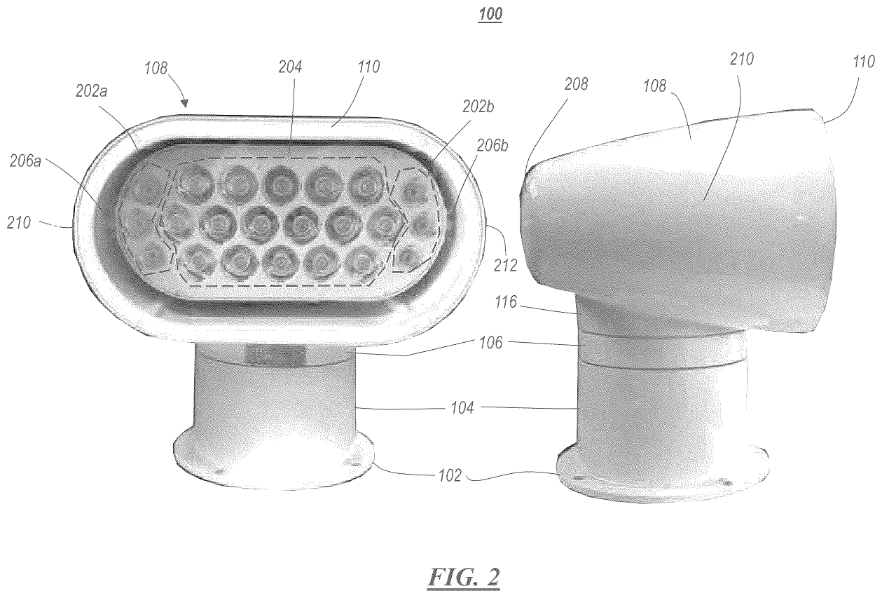

FIG. 1 is a perspective view of the inventive marine lighting system 100. FIG. 2 shows front and side views of the inventive lighting system 100. The lighting system includes a base 102 that is configured to allow the lighting system 100 to be mounted on a marine vessel, such as on the top of the pilot house or similar superstructure of the vessel, or anywhere else that is suitable. For example, the base 1-2 can include a lower ring flange with several openings through it which allow the base 102 of the lighting system 100 to be fastened to a surface using bolts. The base 102 is contiguous to a lower riser 104 which is cylindrical, and the base 102 extends around the circumference of the bottom of the lower riser 104. An intermediate riser 106 sits on top of the lower riser 104, and is configured to rotate on the top of the lower riser 104 in a co-axial manner. The lower riser 104 is fixed and does not rotate. Both the lower riser 104 and the intermediate riser 106 are hollow and can contain other components, such as, for example, a motor and gearing for rotating the portion of the lighting system 100 above the lower riser 104. Further, cabling or other signal conductors and power lines can be routed through the base 102 and risers 104, 106 into the housing 108, which is on top of the intermediate riser 106. The light element housing 108 has a front opening 110 where light elements are provided. The housing 108 is generally hollow to house electrical and mechanical components, and the front opening 110 is open along a generally vertical plane.

In the housing 108 at the front 110 is a tilting light plate 112 on which there are a plurality of light sources, such as LED units 114. There can be a clear lens or clear cover 113 over the opening 110 to prevent water and debris intrusion into the housing 108. The clear cover can be made of a ballistic impact material that is designed to withstand impacts from hard objects. Each LED unit 114 includes a light emitting diode (LED) positioned in a reflective cell having a lens to direct the light emitted by the LED. The lens of each LED unit 114 is configured to either disperse the light, for a flood effect, or to collimate the light, for a spot effect. In some embodiments the opening 110 is oval-shaped, as is the light plate 112. The LED units 114 can be organized into groups 202a, 202b, and 204. Groups 202a and 202b, in the outsides of the LED units 114, can be configured for a flood effect or flood pattern, so that the lighting system 100 can be used as a flood light. Group 204 of LED units 114 can be configured for a spot effect so that the lighting system 100 can be used as a general spot light as well, where the light is provided in a tight beam for a spot pattern. Groups 202a, 202b and 204 can be alternately turned on, or they can all be turned on at the same time. The light plate 112 can be pivoted or tilted on linear mounts 206a, 206b at opposite sides of the light plate 112, which hold the light plate 112 in the housing 108, and allows the light plate 112 to be aimed/tilted up or down, as required and controlled by a user, relative to a horizontal axis 205 defined between the linear mounts 206a. 206b about which the light plate 112 can be tilted up and down. Axles on either side of the light plate 112 can extend into the linear mounts 206a, 206b that can be driven or otherwise controlled by, for example, a stepper motor coupled to the axles to provide the desired degree of tilt of the light plate 112. The housing 108 has a riser interface 116 that fits on top of the intermediate riser 106, and the housing 108 is rotatable on the intermediate riser 106 so that the housing 108 can be rotated three hundred sixty degrees on the risers 106, 104, allowing a user to aim the opening of the light system 100 in any direction. As a result, it is desirable to mount the lighting system on the vessel at a location where it has an unobstructed view around the entire vessel so that it can emit light in any direction, as needed or desired by the vessel operator. The tilting operation of the light plate 112 also allows the vessel operator to aim the light to locations both near and far from the vessel (and all location between near and far). In fact, the light plate can be tilted upward so that the space above the level of the vessel can be illuminated. This can be useful, for example, when passing under bridges.

The housing 108, from a top view, has a rounded trapezoid shape, such that the housing 108 is wider at the front 110, that at the rear 208 of the housing. Likewise, from a side view, the front 110 is taller than the housing is at the rear 208 of the housing. The sides 210, 212 of the housing 108 are semicircular at the front 110 such that the front 110 has an oval shape, being much wider in the horizontal direction than it is tall in the vertical direction. These rounded features, and the cylindrical shape of the risers 104, 106, help reduce wind drag and the tendency of the exterior surface of the housing 108 to collect water. Were the front 110 turned ninety degrees, for example, the same lighting effects could be achieved, but the height of the housing would increase wind drag substantially.

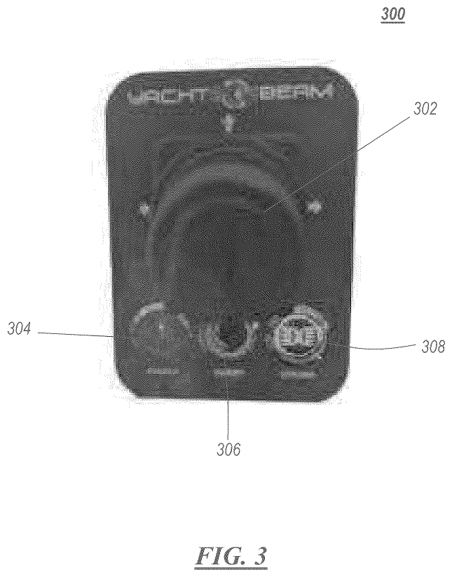

The lighting system 100 is operated remotely using a control unit 300 such as that shown in FIG. 3, which can include several actuators, including a joystick 302, and buttons 304, 306, 308. The control unit 300 can be mounted at a pilot's location, allowing the pilot of the vessel to control the lighting system operation. Moving the joystick up or down causes the light plate 112 to aim up or down, respectively. Moving the joystick left and right will cause the housing 108 to rotate counter-clockwise or clockwise, respectively (looking down from above the lighting system). A button on the top of the joystick 302 can be pressed to cycle between “flood,” “spotlight,” and “all” modes, where the LED units for flood and spot are selectively turned on or off, accordingly. In the “all” mode, all of the LED units are on, both flood and spotlight LED units. The control unit 300 can have a power button 304 that alternately turns the lighting system on and off. When the lighting system 100 is turned off, the housing 108 is autorotated so that the opening 110 is facing the stern (to the rear) of the vessel, presenting the narrower back end 208 of the housing forward to reduce forward wind drag and to keep water spray off of the front of the lighting system 100, and to lower the risk of water intrusion into the housing 108. The housing will remain in that position until the lighting system is turned on. When the power button 302 is pressed to turn the lighting system on, the housing 108 is automatically rotated one hundred eighty degrees so that the front opening 110 is then facing directly forward. The user can then separately control the mode and aim of the lighting system 100, or select an autonomous mode of operation. For example, in a manual operation mode, the user can cycle between flood, spot and “all” modes of operation. The user can also select either a sweep mode by pressing the sweep button 306. The lighting system can also be operated in a strobe mode by pressing the strobe button 308. In the sweep mode, the housing 108 rotates from aiming forward to aiming to port, and then turning to aim to starboard, and repeating this movement, sweeping back and forth between port and starboard. The sweep rate can be selectable, such as by pressing the sweep button 306 to cycle through sweep modes of OFF, SLOW, MEDIUM, and FAST. The rate at which the housing sweeps in each of these modes can be configured by the manufacturer, user, or installer. It is contemplated that cycling through sweep modes may be skipped by holding the sweep button down for a “long press,” which turns off sweep mode and returns the housing to a forward aim, and rotational control back to the joystick 302. Alternatively, the aim of the housing can be entirely manually controlled, allowing the user to aim the light wherever the user wants. In the operating mode the housing can be rotated a full three hundred sixty degrees if necessary. This allows the user to use the spotlight mode to look for things around the vessel. A strobe button 308 alternatively enables or disables a strobe mode where the LED units are strobed (rapidly turning on and off in unison). Or if the strobe button is pressed a second time, the LED units can be operated to emit a continuous “S.O.S” signal which can also be coupled by a second push of the sweep button to make the light continuously rotate 360 degrees for greater visibility in all directions.

In operation, when the lighting system is turned off, the housing is automatically rotated so that the front opening 110 is facing towards the stern of the vessel. Upon turning the lighting system on, such as by pressing the power button 304, the housing will automatically turn one hundred and eighty degrees to face directly forward, towards the bow of the vessel, with at least some of the LED units turned on. The operator can then select between spot, flood, or all modes, and direct the aim of the lighting system using the joystick 302, or enable sweep and/or strobe modes, as needed. In some embodiments, the light plate 112 can auto tilt based on feedback from an accelerometer on the vessel to keep the aim of the lighting system at a selected level. Thus, the operator can control, independently, the mode of lighting output provided by the LED units, and the aim and movement of the lighting system housing 108.

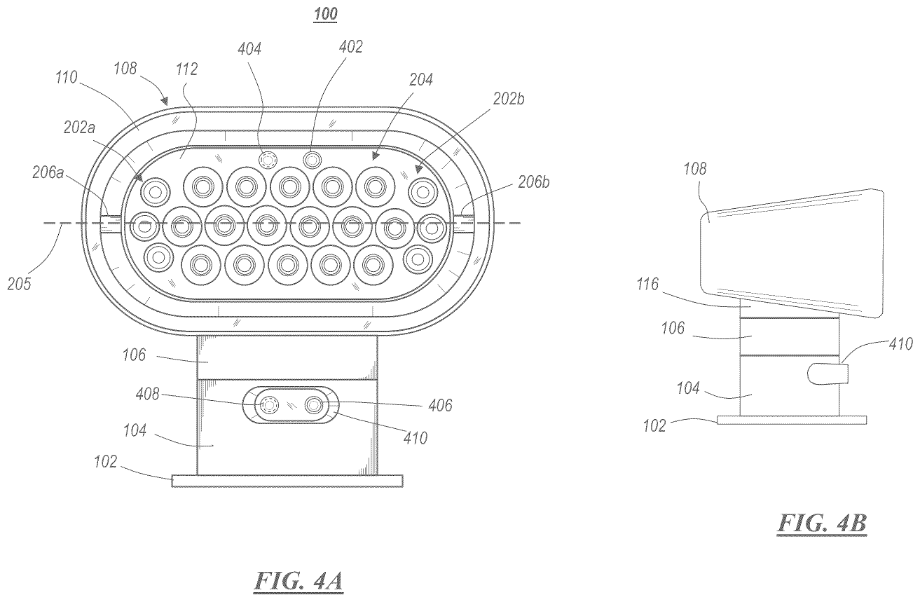

FIG. 4A shows a front view of the marine lighting system 100 including a camera system, in accordance with some embodiments. FIG. 4B shows the same system from a side view. The lighting system 100 is substantially the same as that of FIGS. 1-2, but includes a camera 402 and infrared light source 404. The camera 402 can be sensitive to both visible and infrared light, and collects light onto a digital sensor, as is well known, to provide image/video data to a display which can be located at the pilot station of the vessel, or it can be transmitted wirelessly to a computing device, such as by a wireless local area network, or a personal area network protocol (e.g. BLUETOOTH). The camera 402 and light source 404 are shown on the light plate 112, and therefore move with the housing 108, and tilt with the light plate 112. This allows the operator to aim the camera 402 and light source 404 with the main LED units of the light plate 112. The light sources can be an infrared laser or substantially collimated beam. In addition, or alternatively, there can be a camera 406 and light source 408 on the riser 104 (or on riser 106) in a boss 410 that extends from the column of the riser to provide a mounting region for the camera 406 and light source 408. The light plate 112 is shown in a vertical position, and the light from the LED units would emit outward generally evenly split between the upward and downward directions.

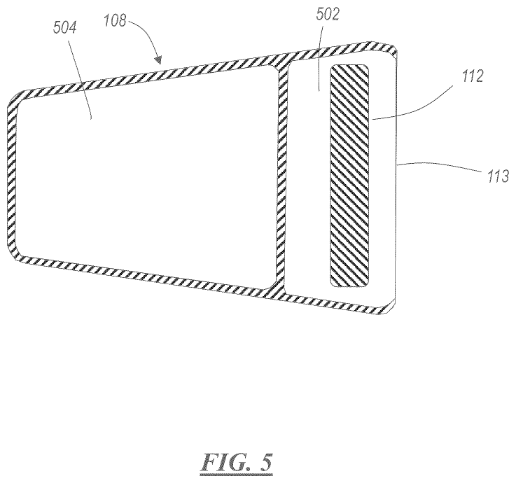

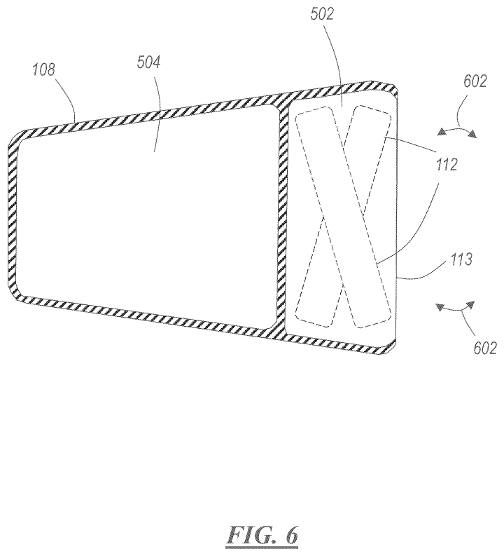

FIG. 5 shows a sectional view of a head portion, which is the housing 108, of a marine lighting system, in accordance with some embodiments. The sectional view is taken centrally through the housing 108 from front to rear, along a vertical plane. The housing 108 can include a forward cavity 502 in which the light plate 112 is mounted, and a rear cavity 504 in which various electrical, electronic, and mechanical components are housed. For example, the motors and coupling members for controlling the tilt of the light plate 112 can be housed in the rear cavity 504. FIG. 6 shows the same sectional view of a head portion of a marine lighting system and how the light plate 112 can be tilted to aim the lighting, vertically, in accordance with some embodiments. The light plate 112 can be tilted as indicated by arrows 602 to aim the front of the light plate 112 up or down. The tilt can be controlled, for example, but the joystick 302 of the control unit 300, and this allows the vessel operator to aim the light at location near the vessel, far away from the vessel, and even above the water and above the vessel.

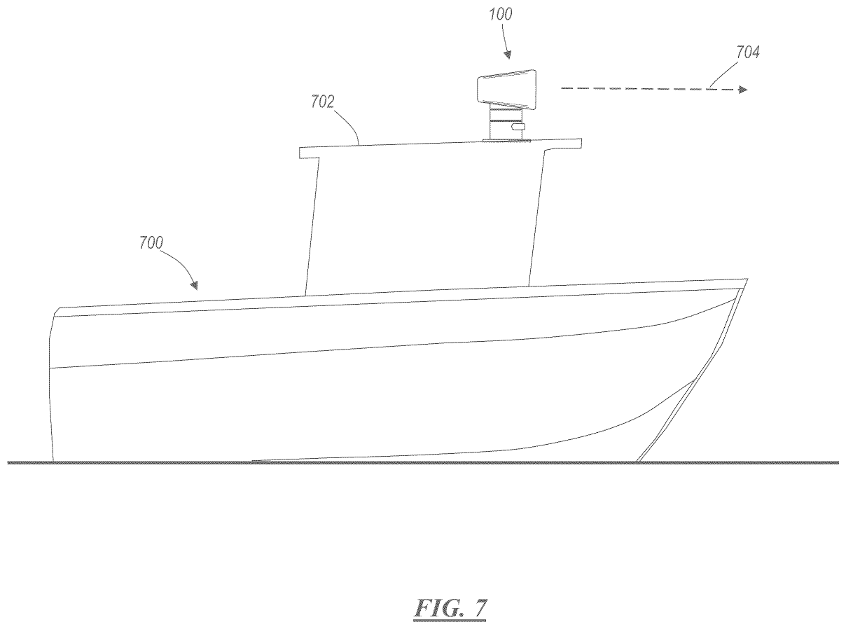

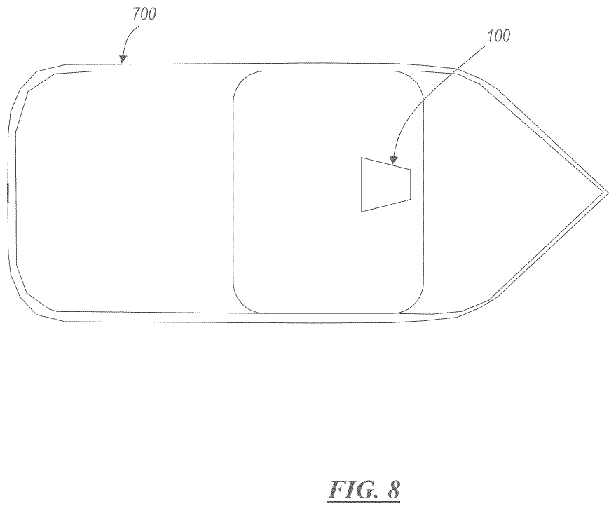

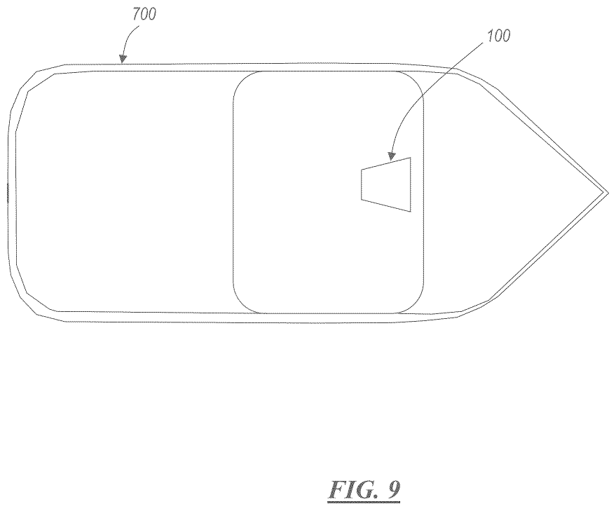

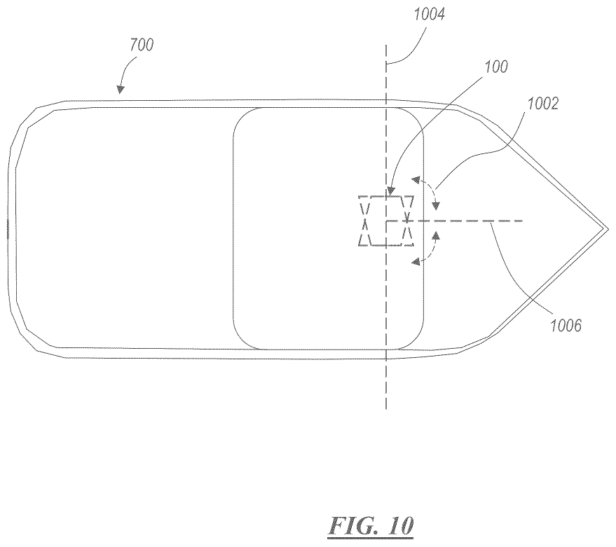

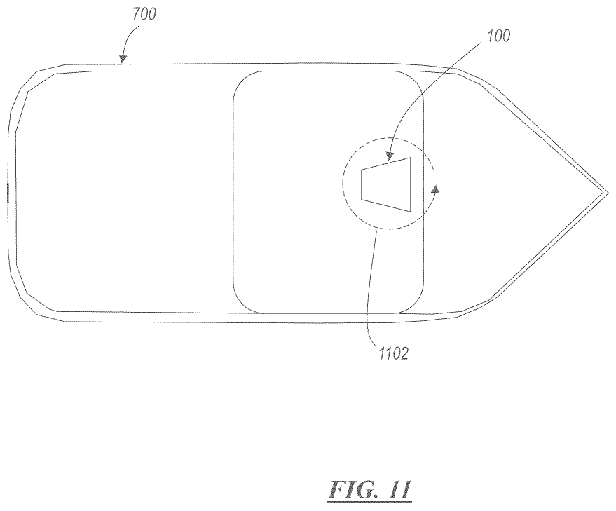

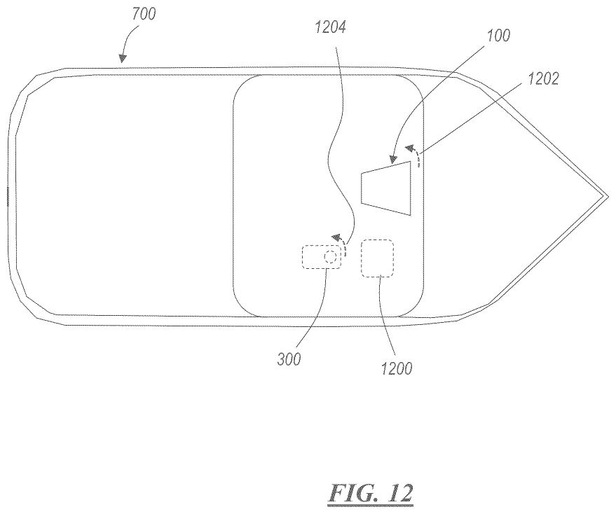

FIG. 7 shows a side view of a marine vessel 700 having a marine lighting system 100 mounted thereon, in accordance with some embodiments. In this case, the lighting system 100 is mounted on top of a pilot house 702 or similar superstructure. This elevates the lighting system 100 for an optimal position from which to emit light. In the present example the light system 100 is turned on and facing forward so that light is emitted generally in the direction of line 704. In general, when the light system is turned on, it will autorotate the housing from facing to the rear of the vessel to facing directly forward, and then the operator can control operation of the lighting system. FIGS. 8-12 show various examples of the functional operation of the lighting system from a top view of the vessel 700. FIG. 8 shows the position of the head of the marine lighting system 100 when the lighting system is turned off, or it has been operated to face to the rear of the vessel during operation. When the lighting system 100 is turned off, or otherwise not in use, the system autorotates the housing to face to the rear of the vessel. In some embodiments, if the lighting system has been turned on, but the light elements have not been turned on for some time, light lighting system can automatically shut off, and rotate the housing to face the rear of the vessel. In FIG. 9 the housing of the lighting system 100 is shown facing forward, as in FIG. 7. After turning on the lighting system by, for example, using the control unit 300, the housing will rotate from the position shown in FIG. 8 to the position shown in FIG. 9. The operator can then select a mode of operation and/or aim the housing as desired. One mode of operation is a “sweep” mode, as indicated in FIG. 10. In the sweep mode the housing of the lighting system 100 start off facing forward, in the direction of line 1006, and then turns ninety degrees to one side, along line 1004, and then it turns one hundred eighty degrees, passing the front-facing direction again, to the other side along line 1004, as indicated by line 1002. This operation is continuous, with the housing sweeping back and forth, at a selected cyclic rate. The operator can have any of the lighting units on to provide a spotlight or flood light, or both, output from the lighting system. The floodlight operation allows the operator to see around the vessel, and any light output allows other vessels to see the lighting system and know that there is a vessel there. In FIG. 11 the housing is shown as being capable of a full rotation in the generally horizontal plane, as indicated by arrow 1102. When operated in a manual mode, the operator can aim the housing using the rotatable element of the joystick, or an equivalent steering control, to point the light output in any desired direction. In generally, as the control is rotated, the housing will track with the rotation of the control. This is also shown in FIG. 12, where arrow 1204 indicated rotation of the control unit 300 (e.g. rotation of a rotatable input device) resulting in a corresponding movement of the housing of the lighting system 100, as indicated by arrow 1202. Thus, the lighting system 100 can be used in both manually controlled and autonomous modes, as desired by the operator, controlled by the control unit 300. Further in FIG. 12, there is shown a display 1200 on which can be displayed image/video from the camera 402, 406 of the lighting system 100. The image can be an optical image or an infrared image, or a hybrid of both. The operator can use the lighting system to illuminate a region, and use the camera 402, 406 to see what is being illuminated, by either or both the visible light sources (202, 204) and/or the infrared light source(s) 404, 408. The image information is then routed to the display 1200 for rendering.

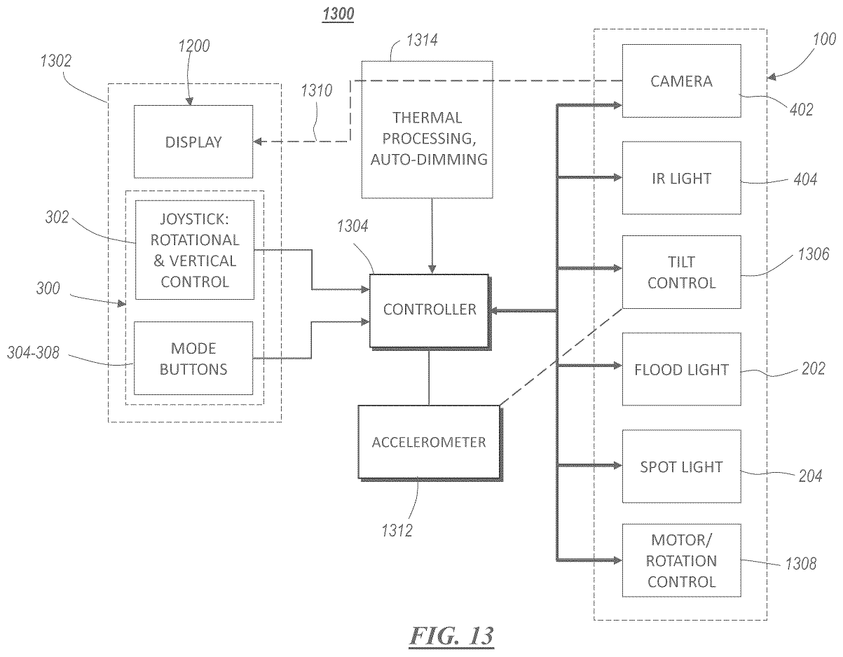

FIG. 13 is a block schematic diagram of a marine lighting system 1300 for a marine vessel, in accordance with some embodiments. The system 1300 includes at least two portions, including a pilot station portion 1302 and a lighting system 100 portion. The lighting system 100 portion includes the base 102, risers 104, 106, and housing 108, as well as all the components to operate the components. A controller 1304 and an accelerometer 1312 can be located in either the pilot station portion 1302 or the lighting system 100 portion, or at a third location. The controller 1304 receives input from the control station 1302, and specifically the control unit 300, and generates signals that are routed to the lighting system 100 that cause the lighting system 100 to respond accordingly. In some embodiments the controller 1304 can include a microprocessor or equivalent logic unit the executes instruction code, and in some embodiments the controller can be analog circuitry, and in some other embodiments the controller 1304 can be a combination of analog and digital circuitry.

The pilot station portion 1302 includes the system components directly used by the pilot or operator of the vessel and these can be located near the steering wheel or similar main station where the pilot or operator would be while the vessel is underway. The lighting system 100 can be, as shown in FIGS. 7-12, mounted near the front of the vessel, or over the pilot's location, with preferably an unobstructed view around the vessel. There would be appropriate cabling and power lines routed to and between these two locations, as would be well understood by those of ordinary skill in installing marine equipment on marine vessels. The pilot station 1302 includes the control unit 300, include the joystick 302 and buttons 304-308, and a display 1200. The display 1200 is coupled 1310 to a camera 402 in the lighting system 100 to receiving image and video information for rendering at the display 1200. The lighting system 100 includes a tilt control that allows the light plate 112 to tilt up or down. This can be controlled manually, and in an autonomous mode the tilt control can be responsive to the pitch changes of the vessel as indicated by an accelerometer 1312. The accelerometer 1312 can provide pitch change data to the controller 1304 which can generate the appropriate signal to the tilt control component 1306. The tilt control component 1306 can act on axles in the linear mounts 206a, 206b that define a tilt axis on which the light plate 112 tilts, as controlled by the tilt control component 1306. There is also a rotation control component 1308, such as a housing motor that is disposed in the riser 104, 106 or the housing 108, which turns the housing 108 relative to the base 102 and risers 104, 106. The rotation of the housing can be alternatively operated manually or autonomously. Rotation can be controlled, for example, using a stepper motor that is response to signals from the controller 1304, which is responsive to input from the control unit 300.

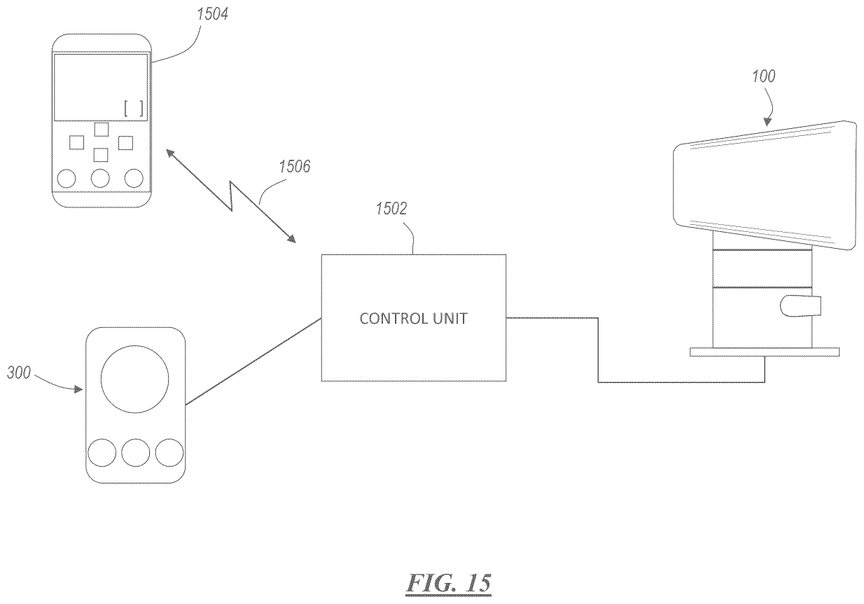

FIG. 15 shows an alternative control arrangement in which a control unit 1502, which would include the controller 1304 and accelerometer 1312 (if present), is coupled to the control unit 300 as previously described. However, the control unit 1304 can also include a wireless network radio transceiver to couple to a mobile device 1504. The mobile device 1504 can run an application program that uses the transceiver of the mobile device 1504 to communicate with the control unit 1502 over a wireless network link 1506 using a radio communication protocol such as for example, those defined by IEEE specification 802.11 (“WiFi”) and/or 802.15 (“BLUETOOTH”). Both control signals and video can be communicated over the wireless link 1506 so that operational control information can be transmitted from the mobile device 1504 to the control unit 1502, and video information can be rendered on the mobile device 1504. The mobile device 1504 can be, for example, a cellular phone device or tablet computing device that provides a touch screen graphical display. The application program can render video from the camera of the lighting system 100 in a window on the display, and the application program can provide virtual control buttons rendered on the display to receive touch input that is used to control the mode of operation, rotation of the housing, and tilt of the light plate of the lighting system 100.

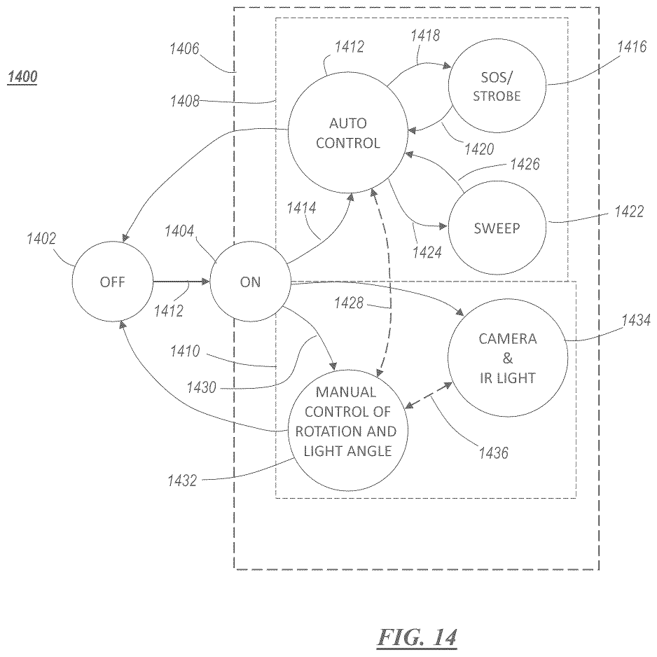

FIG. 14 is a state diagram of operation of a marine lighting system for a marine vessel, in accordance with some embodiments. From each state there are inputs that can cause the lighting system to transition to a new state. Each state represents a mode or state of operation. For example, there is an “off” state 1402 that represents the lighting system when the lighting system is turned off or otherwise not powered up for operation. In the off state the housing is rotated to face the rear of the vessel and the lighting units/LEDs and camera are not powered on or otherwise operable. From the off state 1402 the lighting system can transition to general on state 1406, which includes an initial on state 1404 in which the housing is automatically rotated one hundred eighty degrees to face forward. To transition from the off state 1402 to the initial on state 1404, the user simply presses a power button as indicated by arrow 1412. From the initial on state 1404, the operator can select an autonomous state 1408 or a manual control state 1410. From the initial on state 1404, the default state transition 1430 can put the lighting system in manual control mode 1432. Once in the manual control mode 1432, the lighting system can transition 1428 to the autonomous control mode 1412 by simply pressing one of the autonomous mode buttons. Likewise, by turning off the autonomous mode the lighting system can transition 1428 back to the manual control mode 1432. While in the manual control mode 1432, the operator has direct control of the rotation of the housing, the tilt of the light plate, and the selection of which LED units are turned on (e.g. spotlight, flood, or both). The operator can also control the camera and infrared light in state 1434, either in conjunction with the manual control mode 1432 (as indicated by arrow 1436), or independently from the initial on state 1404.

In the autonomous mode 1408, from the initial selection of an autonomous control mode 1412, the operator can select a sweep mode 1422 by pushing a sweep button (transition 1424). The sweep button can be pushed several times to cycle through different sweep rates and to turn off the sweep mode and return back to the initial autonomous mode 1412 as indicated by transition 1426. In the sweep mode the housing continuously sweeps left and right of the forward direction, typically to about ninety degrees of forward in each direction. Another mode of operation is the strobe mode 1416, to which the lighting system can transition 1418 by, for example, pressing a strobe button at the control. The strobe button can be pressed again to enter a distress mode where the housing is automatically rotated while the lighting units are flashed in a distress code sequence, such as an “SOS” pattern (e.g. in Morse code). Another mode of operation is an auto-rotation mode in which the housing continuously rotates, like a lighthouse light.

A lighting system for marine vessels is disclosed which include a housing capable of rotating in the horizontal plane. The housing holds a light plate with several sets of lighting elements on it to project light outwards generally in a horizontal direction, but the light plate can also be tilted to aim the light up and down, as needed. The lighting elements include a set of flood light elements and set of spot light elements. The flood light elements provide diffuse light in a wade area, while the spot light elements have a tight beam to project light far into the distance. When not in operation, the housing autorotates so that the lighting elements are aimed towards the stern of the vessel, to protect the lighting elements from water spray. When activated, the housing automatically rotates one hundred eighty degrees to face directly forward. The system can operate in either a manual mode or an autonomous mode. In the manual mode a remote joystick can be used to aim the housing and light plate, as well as control which lighting elements are enabled. In the autonomous mode, the housing can be set to sweep from side to side (port to starboard) and varying rates, or turn continuously in full revolutions. The system can also be operated in a strobe mode as part of a defensive act, in the event of people boarding the vessel without permission or authority. The system can also operate in an “SOS” mode and flash an SOS code to attract assistance when needed.

The claims appended hereto are meant to cover all modifications and changes within the scope and spirit of the present invention.

1. A marine lighting system, comprising:
a light, including:
a housing;
a riser system on which the housing is mounted such that the housing is rotatable in a horizontal plane about a vertical axis of the riser system;
the housing having a front opening;
a light plate disposed in the housing at the front opening, the light plate having a plurality of light emitting diode (LED) units in which a first set of LED units of the plurality of LED units is configured to provide a flood pattern of light and a second set of LED units of the plurality of LED units is configured to provide a spot pattern of light, wherein the light plate is mounted in the housing on a horizontal axis allowing the light plate to tilt up and down; and
a control unit that is configured to be remote from the light that controls operation of the light, including a mode of light output from the light, and motion of the light.

2. The marine lighting system of claim 17, wherein the housing is automatically rotated to face forward when the marine lighting system is turned on.

3. The marine lighting system of claim 1, wherein the housing is automatically rotated rearward when the marine lighting system is turned off.

4. The marine lighting system of claim 1, wherein, when a sweep mode is selected at the control unit, the housing is continuously swept left and right from forward, at one of several selectable sweep speeds, while at least one of the first set of LED units or the second set of LED units are enabled to produce light.

5. The marine lighting system of claim 1, wherein, when an auto rotation mode is selected at the control unit, the housing is continuously rotated while at least one of the first set of LED units or the second set of LED units are enabled to produce light.

6. The marine lighting system of claim 1, wherein, upon selecting a strobe mode at the control unit, at least one of the first set of LED units or the second set of LED units are enabled to produce light in a strobe sequence.

7. The marine lighting system of claim 1, wherein, upon selecting a distress mode at the control unit, at least one of the first set of LED units or the second set of LED units are enabled to produce light in a distress code sequence.

8. The marine lighting system of claim 1, wherein the light plate is covered with a clear lens made out of ballistic impact material.

9. A marine lighting system, comprising:
a riser that is configured to be mounted on a surface;
a housing disposed on the riser and that is rotatable on the riser about an axis that is perpendicular to the surface, the housing having a front opening;
a housing motor coupled to the housing at an inside of the housing or the riser that is configured to rotate the housing;
a light plate that is mounted in the front opening at opposite sides of the light plate, and wherein the light plate is configure to tilt up and down;
a tilt control in the housing that is responsive to a tilt control signal to adjust a tilt angle of the light plate;
a first plurality of light elements disposed on a front of the light plate which are configured to provide a flood pattern of light;
a second plurality of light elements disposed on the front of the light plate which are configured to provide a spot pattern of light; and
a control unit including actuators for controlling a rotational position of the housing, the tilt angle of the light plate, operation of the first plurality of light elements, and operation of the second plurality of light elements.

10. The marine lighting system of claim 9, further comprising:
a camera mounted either on the housing or on the light plate which produces image information; and
a display that is operatively coupled to the camera and which displays the image information graphically.

11. The marine lighting system of claim 9, wherein the housing motor is operated to automatically aim the housing forward when the marine lighting system is turned on, and operated to automatically aim the housing rearward when the marine lighting system is turned off.

12. The marine lighting system of claim 9, wherein the housing motor is operated, when a sweep mode is selected at the control unit, to continuously sweep the housing left and right from forward, at one of several selectable sweep speeds, while at least one of the first plurality of lighting elements or the second plurality of lighting elements are enabled to produce light.

13. The marine lighting system of claim 9, wherein the housing motor is operated, when an auto rotation mode is selected at the control unit, to continuously rotate the housing while at least one of the first plurality of lighting elements or the second plurality of lighting elements are enabled to produce light.

14. The marine lighting system of claim 9, wherein, upon selecting a strobe mode at the control unit, at least one of the first plurality of lighting elements or the second plurality of lighting elements are enabled to produce light in a strobe sequence.

15. The marine lighting system of claim 9, wherein, upon selecting a distress mode at the control unit, at least one of the first plurality of lighting elements or the second plurality of lighting elements are enabled to produce light in a distress code sequence.

16. The marine lighting system of claim 9, wherein the light plate is covered with a clear lens made out of ballistic impact material.

17. The marine lighting system of claim 1, wherein the housing has a rounded trapezoid shape that is wider at the front than at the rear, and taller at the front than at the rear from a side view, with sides that are semicircular at the front such that the front opening is oval-shaped and wider in a horizontal direction than it is tall in a vertical direction, wherein the housing is automatically rotated on the riser to face rearward when the lighting system is turned off such that the narrower rear end of the housing faces forward.

18. The marine lighting system of claim 1, wherein each LED unit of the plurality of LED units comprises an individual lens, wherein the individual lenses of the first set of LED units are configured to produce the flood pattern and the individual lenses of the second set of LED units are configured to produce the spot pattern.

19. The marine lighting system of claim 1, wherein the first set of LED units is comprised of a first group and a second group, the second set of LED units are all grouped together centrally on the light plate, the first group of the first set of LED units are disposed on a right side of the second set of LED units, and the second group of the first set of LED units are disposed on a left side of the second set of LED units.

20. The marine lighting system of claim 9, wherein the first plurality of light units is comprised of a first group and a second group, the second plurality of light units are all grouped together centrally on the light plate, the first group of the first plurality of light units are disposed on a right side of the second plurality of light units, and the second group of the first plurality of light units are disposed on a left side of the second plurality of light units.
